(19) United States
(12) Patent Application Publication
(10) Pub. No.: US 2023/0334253 A1
(43) Pub. Date: Oct. 19, 2023

(54) EVENT REPRESENTATION IN EMBODIED AGENT

(71) Applicant: SOUL MACHINES LIMITED, Auckland (NZ)

(72) Inventors: Mark Sagar, Devonport (NZ); Alistair Knott, Roslyn (NZ); Martin Takac, Bratislava (SK)

(21) Appl. No.: 18/028,094

(22) PCT Filed: Sep. 24, 2021
(86) PCT No.: PCT/IB2021/058708

§ 371 Date: Mar. 23, 2023

Related U.S. Application Data
(60) Provisional application No. 63/109,336, filed on Nov. 3, 2020.

(30) Foreign Application Priority Data
Sep. 25, 2020 (NZ) 768405

(51) Int. Cl. G06F 40/30

(52) U.S. Cl. CPC G06F 40/30

(57) ABSTRACT

A computer implemented method for parsing a sensorimotor Event experienced by an Embodied Agent into symbolic fields of a WM event representation mapping to a sentence defining the Event is described the method including the steps of: attending a participant object; classifying the participant object; and making a series of cascading determinations about the Event, wherein some determinations are conditional on the results of previous determinations, wherein each determination sets a field in the WM event representation

### TECHNICAL FIELD

Embodiments of the invention relate to natural language processing and cognitive modelling. More particularly but not exclusively, embodiments of the invention relate to cognitive models of event representation and event processing.

### BACKGROUND ART

Humans parse their experiences of the world into units called events (see e.g. Radvansky and Zacks, 2014). Events are the kind of happenings that can naturally be conveyed in sentences: for instance ‘Mary grabbed a cup’, ‘The cup broke’, ‘John sighed’. In computational modelling of human cognitive processes, the event representation problem refers to how to encode events in working memory (WM) and long term memory (LTM). The event processing problem refers to what sensory mechanisms are employed to process events taking place in the world and construct WM event representations, and what sensorimotor mechanisms allow an n embodied agent to produce events in the world, in the form of motor actions?

Existing Models of Thematic Roles

In the linguistic literature, models of thematic roles attempt to define the different semantic roles that noun phrases (NPs) can play in a sentence. These models often implicitly define a system of event types, where the type of an event is partly determined by the thematic roles of its participants.

Dowty (D Dowty. Thematic proto-roles and argument selection. Language, 67(3):547-619, 1991) refers to two basic thematic roles: ‘proto-agent’ and ‘proto-patient’. For Dowty, the concepts of ‘agent’ and ‘patient’ are prototypes, admitting of degrees of membership: the important thing is the degree to which participants in an event have agent-like and patient-like properties. In a model of argument linking, Dowty associates thematic roles with grammatical positions (in particular subject and object). The participant with most agent-like properties (e.g. movement, independent existence, sentience, and causative agency) will be expressed as the subject of the sentence. The proto-patient is the participant that has most patient-like characteristics: these include lack of movement, change-of-state, and the undergoing of caused processes. In ‘Mary grabbed the cup’, the referent of ‘Mary’ has the most agent-like properties, and for this reason ‘Mary’ is the subject of the sentence’, while in ‘The cup was grabbed’, the referent of ‘the cup’ has the most agent-like properties (of necessity, as it's the only NP), and thus ‘the cup’ is the subject of the sentence.

‘Agent-like’ object properties attract attention (see e.g. Koch and Ullman, 1985; Ro et al., 2007 for results in visual attention). Attention is competitive: the item attended to first is the one that has the most properties that attract attention.

Roles associated with change-of-state events. An influential proposal is that a transitive sentence like ‘Mary broke the glass’ implicitly conveys a causative process, that can be glossed as ‘Mary caused [the glass to become broken]’, while an intransitive like ‘The glass broke’ conveys the structurally similar ‘Something caused [the glass to become broken]’. In this analysis, the referent of ‘glass’ occupies the same structural position in the semantics of these two sentences, and it's the item in this position that undergoes the change-of-state; the grammatical position of ‘glass’ is thus free to vary.\

Existing Models of Event Storage in Long-Term Memory

In cognitive models, events are typically represented in WM before they are stored in LTM. Takac and Knott (2016) provide a WM representation of an event allowing the expression of queries to LTM, that retrieve stored events that match certain partially-specified event templates. For instance, the WM medium holds a query like ‘What did Mary grab?’, as well as the retrieved answer (‘Mary grabbed the cup’). WM event representations are ‘place-coded’ for semantic roles. The primary medium holding object representations just represents one object at a time in a ‘current object’ medium.

WM representation of the event being experienced is authored progressively, as experience proceeds, as described in: M Takac and A Knott. Working memory encoding of events and their participants. In CogSci, pages 2345-2350, 2016a. When the process of experiencing the event is finished—which is normally when the event itself finishes—the WM representation of the event will be complete, and the complete event representation can be stored in longer-term memory, as described in: M Takac and A Knott. Mechanisms for storing and accessing event representations in episodic memory, and their expression in language: a neural network model. In CogSci, pages 532-537, 2016b.

However the prior model has several drawbacks: it does not account for how semantic participants in an event are realised syntactically. Semantic/thematic roles do not map to syntactic positions. For instance, in an active sentence, the subject position reports the AGENT of the event, and the object reports the PATIENT, but in a passive sentence, the subject position reports the PATIENT. There is similarly no way to read out nominative and accusative Case. Prior models also fail to support change of state events or causative events.

Existing Models of Event Perception: Tracking Processes, Deictic Routines and Cognitive Modes

An embodied agent “perceiving” an event involves attending to its participant objects and classifying them; visual attention and visual object classification are both well-studied processes. When watching a transitive action, the observer also uses special mechanisms to attend to the target object while the action is under way; gaze following and trajectory extrapolation are important sub-processes here. There are also brain mechanisms specialised in detecting changes in location or intrinsic properties (see e.g. Snowden and Freeman, 2004), and still more specialised mechanisms for classifying the movements of animate agents (see e.g. Oram and Perrett, 1994). Detection of changes or movements in an attended object require this object to be tracked over a continuous period of time, because changes take time to register (see Kahneman et al., 1992 for a good introduction to this principle). Several theorists envisage a role for multiple object-tracking processes during event perception, as there are often several moving things to be monitored (see e.g. Cavanagh, 2014).

Ballard, 1997, Knott, 2012; Knott and Takac, 2020 propose that event perception is structured as a discrete, sequential process called a deictic routine. A deictic routine is a sequence of relatively discrete cognitive operations, that operate on an embodied agent's current focus of attention, and potentially update this focus. Deictic routines apprehend certain specific subtypes of event, with a focus on events involving transitive actions. An embodied agent first attends to (and classifies) the agent of the action, then attends to (and classifies) the patient of the action, and then classifies the action itself.

PCT/IB2020/056438 covered the execution of actions, as well as their perception. To distinguish these operations, the embodied agent is placed into distinct cognitive modes—that is, distinct patterns of neural connectivity. The first operation in our deictic routine (‘attention to the agent) either involves attention to an external individual or attention the embodied agent. These operations trigger different/alternative cognitive modes: ‘action perception mode’ in the former case, ‘action execution mode’ in the latter case.

### OBJECT OF INVENTION

It is an object of the invention to improve event representation in embodied agents, or to at least provide the public or industry with a useful choice.

### SUMMARY OF THE INVENTION

In one embodiment the invention consists of a computer implemented method for parsing a sensorimotor Event experienced by an Embodied Agent into symbolic fields of a WM event representation mapping to a sentence defining the Event including the steps of:
a. attending a participant object;
b. classifying the participant object; and
c. making a series of cascading determinations about the Event, wherein some determinations are conditional on the results of previous determinations,
d. wherein each determination sets a field in the WM event representation.

In a further embodiment at least, some determinations may trigger alternative modes of cognitive processing in the Embodied Agent.

In a further embodiment the determinations for alternative modes of cognitive processing in the Embodied Agent may include the steps of:
a. defining an evidence collection process, that separately accumulates evidence for each mode over some period of time predating the time when the choice is to be made by an arbitrary amount; and
b. for each mode storing the accumulated evidence into a continuous variable denoting the amount of evidence accumulated for that mode,
c. determining the mode of cognitive processing is made by consulting the evidence accumulator variables for each mode.

In a further embodiment, determinations may be selected from the group consisting of:
a. determining whether a second object exists;
b. determining whether there is evidence for an action of creation;
c. determining whether an object is undergoing a change-of-state; and
d. determining whether an object is exerting a causative influence, and/or executing a transitive action.

In a second embodiment the invention consists in a data structure for parsing a sensorimotor Event experienced by an Embodied Agent into symbolic fields of a WM event representation including:
a. a WM Event Representation data structure including:
b. a causation/change area configured to store a causer/attender object and a changer/attendee object;
c. stored sequence area configured to store the first-attended object and second-attended object, holding re-representations of the objects in the causation/change area;
d. an action;
e. cause flag
f. a field signalling that a change-of-state is under way; and
g. a result state.

In a further embodiment determinations data structure may include a deictic representation data structure including current object, configured to simultaneously map to both the causation change area and the stored sequence area.

In a third embodiment the invention consists in a method for attending to objects by an embodied agent, including the steps of:
a. simultaneously assigning a causer/attender tracker and a changer/attendee tracker to a first object attended to by the embodied agent;
b. determining whether the first object is a causer/attender or a changer/attender; and
c. if the first object is a causer/attender, reassigning the changer/attendee tracker to the object being attended.

In a further embodiment attending the object is causally influencing the object.

### BRIEF DESCRIPTION OF DRAWINGS

FIG. 1 shows a diagram of the a WM event representation system;

FIG. 2 shows a flowchart showing the sequence of determinations in an event-apprehension process by an embodied agent.

FIG. 3 shows examples illustrating the coverage of the WM event medium.

FIG. 4 shows a further flowchart showing the sequence of determinations in an event-apprehension process by an embodied agent.

### DISCLOSURE OF INVENTION

In embodiments described herein, a Cognitive System includes an Event Processor which parses sensorimotor experiences into events. The Event Processor may map Events experienced by an Agent to sentences.

WM representations of events take the form of stored deictic routines. Deictic routines provide the principle of compression that allows complex real-time sensorimotor experiences to be efficiently encoded in memory. WM encodings of events allow replay of deictic routines and simulation of stored events. Simulated replay underlies the process of sentence generation. WM representations of events store copies of deictic object representations activated during event processing. This allows a place coded model of role-binding in WM event representations, and supports a simple model of the interface with LTM. LTM event encodings are stored associations between WM event fields which can be queried with partial WM event representations.

In an event perception model, when an object participant is attended to, a visual tracker is placed on the participant. Multiple objects trackers are employed, and an action classifier consults the agent and patient trackers for specific purposes.

In one embodiment, the agent is always the first-attended object, and patient is always the second-attended one. agent and patient are prototype categories, and that participants essentially compete to be the agent. Prototypical agent qualities are those that attract attention.

A Go/Become action type represents change of state events. A field holding the result state for these events may be added—which can be a property, or a location. A CAUSE flag is used for events where there's an identified cause of the change of state.

Extended Model of WM Event Representations.

In one embodiment, a cognitive system combines a Dowty-style model of attentional prominence with a L&RH-style model of change-of-state events.

A model of event representation represents key participants of an event in WM both in relation to serial attentional processes (as first-attended and [optionally] second-attended object) and in relation to causation/change processes (as changing-object and [optionally] causing-object). Thematic roles are represented on two largely orthogonal dimensions.

This allows a much clearer statement of the mapping to language. A ‘stored sequence’ area expresses rules about which participants are expressed as grammatical subject and object, and which participants receive nominative and accusative Case (in languages like English). The ‘causation/change’ area models the causative alternation, and expresses rules about which participants receive ergative and absolutive Case (in ergative languages). The model also allows a good account of so-called ‘split ergative’ languages, which use a mixture of both Case systems.

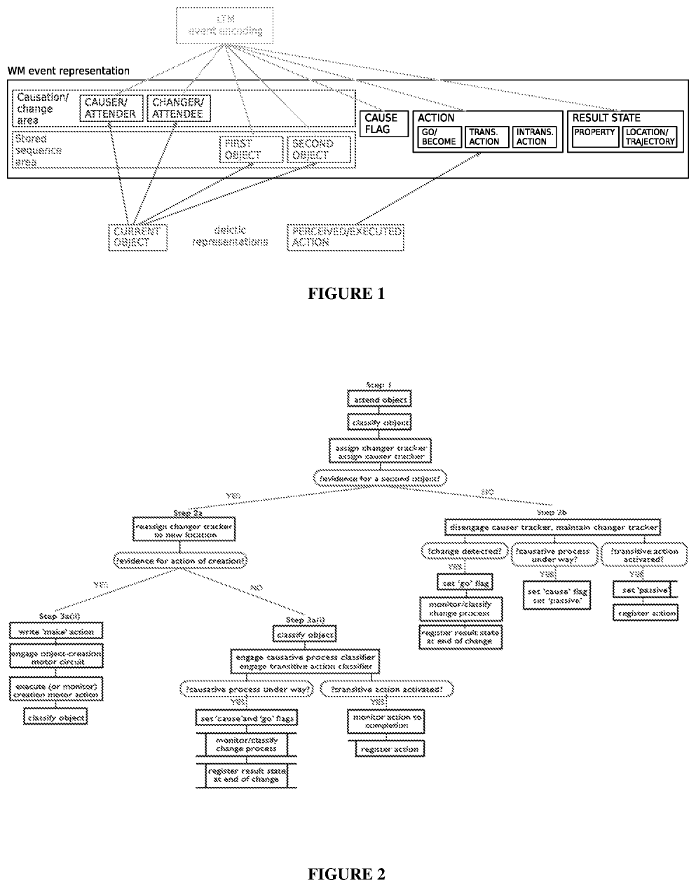

FIG. 1 shows an interface with an LTM event storage system, including a dual representation of object participants. LTM event representations in our model are stored associations between all the fields of the WM event medium, in which the key participants feature twice.

The fields in the ‘causation/change’ area are defined as agent/patient prototypes: the concept of ‘causer’ is combined with the concept of ‘attender’, and the concept of ‘changing-object’ is combined with the concept of ‘attendee’, so these fields can serve to hold the agent and patient of transitive actions. The rationale for these combinations is that most transitive actions also achieve causative effects on the target object. Desirably, prototype definitions pay heed to this generalisation—but they still allow transitive actions that don't have causative effects on the target (like ‘Sue touched the cup’), and for causative events involving nonvolitional causers (like ‘The wind rustled the leaves’).

The Causation/Change Area

The causation/change area, represents events in which objects change (as reported in sentences like The glass broke and The spoon bent), and causative processes that bring these changes about (as reported in sentences like John broke the glass, or The fire bent the spoon). This area contains two fields, which are each defined as a cluster of related concepts.

The Changer/Attendee Field

The changer/attendee field represents an object that undergoes a change, either in location (for instance an object that moves), or in intrinsic properties (for instance an object that bends or breaks). This field can also be used to represent the agent of an intransitive volitional action, such as a shrug or a smile. Such actions bring about changes to the configuration of the agent's body: in this sense, the agent ‘undergoes a change’, just like a spoon that bends. (Note that bend can be a volitional intransitive action, as in John bent down.)

The changer/attendee field also represents the patient of a transitive action. This patient isn't always changed: for instance, I can touch a cup without affecting it. But transitive actions typically change the target: so the roles of ‘patient’ and ‘change-undergoer’ often coincide. A disjunctive definition of the changer/attendee field captures this regularity.

The Causer/Attender Field

The causer/attender field represents an object that brings about a change in the changer/attendee. For instance, in John bent the spoon, it represents John, and in The fire bent the spoon, it represents the fire. By a similar disjunctive definition, this field also represents the agent of a transitive action: transitive actions needn't bring about changes on the target object, but they often do, so the agent is often a causer too.

Note that the observing agent can attend to herself as the causer/attender. An ‘attention to self’ operation results in the observer performing an action, rather than passively observing one. If the observer makes herself the causer/attender, her choice of what to do is again guided by reconstruction of a ‘desired’ action event from the LTM event medium. While reconstruction of fields can be done in parallel, it still informs a strictly sequential deictic routine. The serial order of this routine is the same for passively perceived events and actively ‘performed’ events.

Optionality of the Causer/Attender

The causer/attender field doesn't have to be filled—this information is captured separately, in the ‘stored sequence’ area. Allowing the causer/attender field to be blank enables representation of ‘pure change-of-state events’ like The glass broke, which have no reference to a causer. It also supports representation of passive events, like John was kissed, which have no reference to an agent.

Supporting Generalisations in the LTM Events Network

The causation/change area makes useful generalisations over change-of-state events. Consider an event where a glass breaks, and another where some agency (John or the fire) causes the glass to break. Desirably, the LTM event-encoding medium represents similarities between these: in particular, its representation of the change that occurs is the same. The causation/change area achieves this: an event is stored in which John breaks the glass, and then we query the LTM medium with the question ‘Did the glass break?’—the answer will be (correctly) affirmative.

Support for an Account of Ergative and Absolutive Case

The causation/change area also provides a basis for an account of ergative and absolutive Case. The changer/attendee field holds the agent of intransitive event sentences, and also the patient of transitive event sentences, while the causer/attender field holds the agent of transitive sentences. If an event participant features as changer/attendee, it is therefore eligible for ergative Case, and if it features as causer/attender, it is eligible for absolutive Case.

The ‘Cause’, ‘go/Become’, ‘Result State’ and ‘Make’ Fields

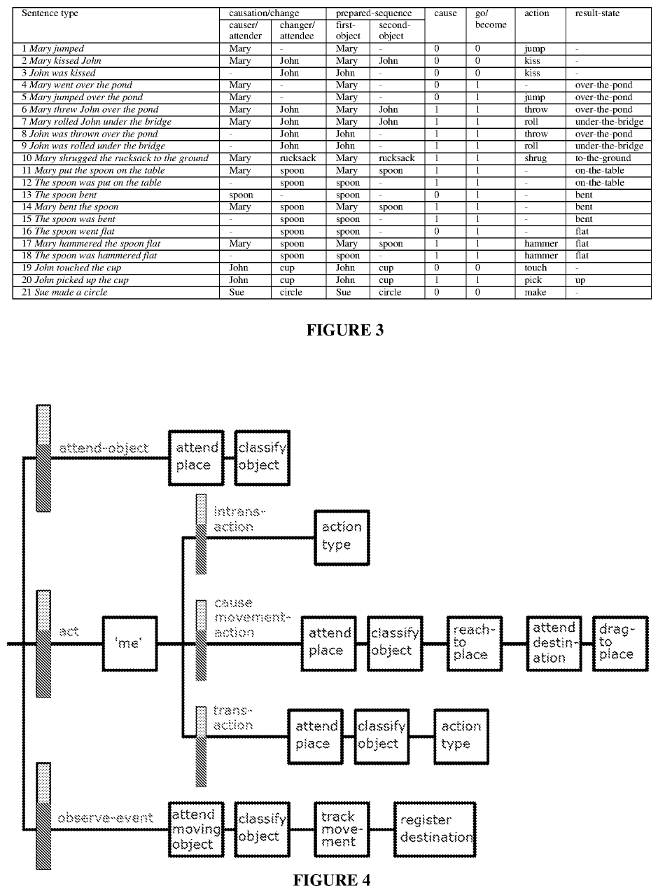

The new WM event scheme shown in FIG. 3 also includes some additional fields for representing change-of-state events. The ‘action’ field now includes a category of action called go/become. If the observer registers a change-of-state event, this category of action is indicated. (Note that the verb go can indicate a change in intrinsic properties (John went red) as well as a change in location (John went to the park.)

A result state field holds the state that is reached during a change-of-state event. This field has sub-fields for specifying object properties (such as ‘red’) and locations/trajectories (such as ‘to the park’).

The new WM scheme also features a ‘cause’ flag, that indicates for change-of-state events whether a causal process bringing about the change-of-state is identified. This flag is set in events like John bent the spoon or The fire bent the spoon, but not in The spoon bent. A causal process can be identified even if the causer object is not attended to. This allows representation of passive causatives, such as The spoon was bent, which conveys that ‘something caused the spoon to bend’, without identifying that thing.

Finally, the new WM scheme features a special transitive action called ‘make’, which is used to represent actions where an object is created, rather than simply altered. ‘Actions of creation’ can involve reassembling materials into a new form, or manipulating the form of existing objects. But they can also involve the production of transiently existing things, such as sounds (making a noise, making a song) or the production of symbolic artefacts, for instance through drawing or painting (making a line, making a triangle). The ‘make’ action can be realised by various different words: for instance in English, the verb do can often be used (especially in child language) as well as the verb make. Particular subtypes of making are expressed with different verbs: for instance the agent can sing or play a song, and draw or paint a picture. In many languages, the general verb make can also be used in place of the verb cause. (For instance, in English it is possible to say Mary caused the cup to break, but also Mary made the cup break.)

The Stored Sequence Area

The stored sequence area, shown in green, holds event participants in the order they were attended to. The information is stored separately from encodings of causality and change. Two fields, called first-object and second-object, take copies of the first and second objects attended to. There is no second object in passives (Mary was kissed, The spoon was bent) and in pure change-of-state sentences (The spoon bent).

The objects occupying the ‘first-object’ and ‘second-object’ fields are semantically heterogeneous, just like those occupying the ‘causer/attender’ and ‘changer/attendee’ fields. But again, useful generalisations are captured across these categories. In particular, volitional agents of actions always occupy the first-object field, whether the action is transitive or intransitive, and whether it is causative or not. In one embodiment, the LTM event-encoding medium encodes the volitional agent of actions in the same way, so allowing queries such as ‘What did John do?’, and to retrieve all events, whether transitive or intransitive, causative or non-causative.

Note also that the ‘first-object’ and ‘second-object’ fields provides a good basis for an account of nominative and accusative Case. Recall from Section 1 that the agent of active transitive and intransitive sentences receives nominative Case, as does the patient of passive sentences: the patient of active transitive sentences is the exception, in receiving accusative Case. In our model, if an event participant features as first-object, it is eligible for nominative Case, and if it features as second-object, it is eligible for accusative Case. These features also identify the (surface) subject and object of sentences: the participants receiving nominative and accusative Case appear as the subject and object of the sentence respectively.

The distinction between first-object and second-object also corresponds to a well-known classification of event participant roles—namely, that proposed by Dowty 1991. Dowdy's interest is precisely in stating a general proposal about how semantic features of event participants determine the syntactic positions they hold within sentences (subject and object). Dowty defines a ‘proto-agent’ and ‘proto-patient’. The proto-agent is defined via a cluster of agent-like features, including things like animacy, volitionality, sentience and causal influence. The proto-patient is defined via a cluster of patient-like features, including relative lack of movement, and the undergoing of state changes. Crucially, the participant that becomes the subject is the one that has the most agent-like features: for Dowty, participants are essentially in competition to occupy the subject position. In our model, this competition is an attentional competition: the participant attended to first occupies the ‘first-object’ field, and through this is selected as the grammatical subject.

FIG. 3 illustrates the range of sentence types that can be modelled with the system described herein. For each sentence type, the contents of each field of the WM event medium is indicated.

Event Processing

In one embodiment, a declarative model of event representations informs a new model of event processing, that covers a wider range of event types. In a model of event processing structured as deictic routines, some operations in this routine involve making a choice between alternative cognitive modes.

FIGS. 2 and 4 show an embodied agent making a sequence of determinations in an event-apprehension process. The Embodied Agent begins the routine by attending sequentially to the key participants in the event. As the Embodied agent attends to participants, the embodied agent categorizes the type of event the agent is perceiving. Specifically, when the agent attends to the first object, the agent determines whether this object should be recorded in the causation/change area as the ‘causer/attender’ or the ‘changer/attendee’. That is, is the object undergoing a change-of-state (or transitive action), or is it exerting a causative influence (or executing a transitive action) on something nearby?

If the object is undergoing a change of state (transitive action), the event is categorized as a pure change-of-state event (like ‘The cup broke’ or ‘The clay went soft’ or ‘The ball went through the window’), or a passive event (like ‘The cup was grabbed’). If the object is exerting a causative influence, the event is categorized as a causative change-of-state event (like ‘Sally broke the cup’) or a pure transitive event (like ‘John touched the cup’)—or a mixture of the two (as in ‘Fred pounded the clay soft’, or ‘Mary kicked the ball through the window’).

This initial determination establishes the cognitive mode of the embodied agent: ‘causer/attender mode’ or ‘changer/attendee mode’. These different/alternative modes activate different perceptual processes, suitable for the identified event type. In this model, the deictic routine involved in apprehending an event involves a sequence of discrete choices, with earlier choices setting up later ones.

The algorithm shown in FIG. 2 deploys visual and cognitive mechanisms involved in event processing to apprehend complete events of different kinds as described in detail below:

Rectangular boxes de-note deictic operations. Rounded boxes denote choice points, dependent on the results of processing conducted earlier in the routine. The main operations deploying object trackers, engaging classifiers, and registering ‘registering’ results of processing in the WM event medium.

Step 1: Attending to a First Object

Step 1 in the extended deictic routine is to attend to the most salient object in the scene, and to assign both trackers to this object. Assigning the changer tracker allows the object classifier to generate a ‘current object’ representation.

Step 2: Deciding on the Role of the First Object

At step 2, the agent decides what kind of event the attended object is participating in. The first decision is whether to copy the object representation to the causer/attender field, or to the changer/attendee field. Evidence for the changer/attendee field is assembled by the change detector, which is referred to the attended object by the changer tracker. Evidence for the causer/attender field is assembled jointly by the directed attention and causative influence classifiers, which are both referred to the attended object by the causer tracker. If the object is established as causer/attender, the algorithm proceeds to Step 2a; if it is established as changer/attendee, the algorithm proceeds to Step 2b. In either case, the object representation is also copied to the ‘first-object’ field of the WM event.

Step 2a: Processing Events Involving a Second Object

In Step 2a, the causer tracker is retained on the current object, and an attempt is made to reassign the changer tracker to a new location. To do this, the directed attention and causative agency classifiers are used to seek locations that are the focus of joint attention, or directed movement, or causative influence. The embodied agent then attends to the selected location, and reassigns the changer tracker to this object. The object classifier then attempts to produce a representation of this new object in the ‘current object’ medium. The object classifier operates on the changer region.

At this point, another choice arises, relating to the ‘actions of creation’: whether the observed agent is acting on an object that already exists, or is she acting to create an object where one doesn't yet exist? As with the decision about causality, this choice plays out differently depending on whether the observer is in ‘action perception mode’, watching an agent separate from herself, or in ‘action execution mode’, playing the role of the agent herself. In action perception mode, various signals diagnose an action of creation. These all relate to the output of the object classifier directed to the changer region. If this classifier indicates that there is no object at all in this region, this is a good indication that an action of creation is underway, with this region as the agent's selected ‘workspace’. (This explains the agent's attention to the region.) If the classifier identifies an object, but the type of the object appears to be unstable, or in flux, this is another good indication that the agent is making something. If, on the other hand, the classifier clearly identifies an object with an unchanging type, the observer can conclude that the event involves an existing object. In this latter case, she will implement Step 3a(I), to process a transitive and/or causative event. In the former case, she will implement Step 3a(ii), to process an action of creation.

In action execution mode, the crucial issue is whether the desired event reconstructed top-down involves a ‘make’ action. If some verb other than make is strongly reconstructed, the observer will implement Step 3a(i); if ‘make’ dominates in the reconstruction, the observer will implement Step 3a(ii).

Step 3a(i): Processing a Transitive and/or Causative Event

In Step 3a(i), the observer has decided that the observed agent is acting on an existing object, whose type is not changing. The observer begins by copying the identified object representation to the changer/attendee field of the WM event, and to the ‘second-object’ field.

At this point, she is able to deploy the two classifiers that operate jointly on the causer and changer regions: the transitive action classifier (which looks for actions done by the causer on the changer, such as ‘Mary slapped the ball’), and the causative process classifier (which looks for causative influences of the causer on the changer, such as ‘Mary moved the ball down’). Note that these classifiers can both fire, if the causative process also happens to be a transitive action, as in ‘Mary slapped the ball down’. If acausative process is identified, the observer sets the ‘cause’ flag in the WM event, and also the ‘go/become’ flag (because what is being caused is a change). If not, she doesn't.

If a change is being caused, the embodied agent monitors the change to completion, and in a final step, the ‘result state’ reached is written to the WM event. This result state can involve the final value of an intrinsic object property that has been changing (e.g. ‘flat’, ‘red’), or the final location of an object that has been moving (e.g. ‘to the door’), or the complete trajectory of a moving object (e.g. ‘through the door’).

Step 3a(ii): Processing an Action of Creation

In Step 3a(ii), the observer has decided that the observed agent is executing an action of creation.

If the observed agent is the observer herself, she must first decide what to create before any motor action can be programmed. Again, in this decision she is driven by the desired event that is reconstructed in the WM event medium. There might be a mixture of objects reconstructed here: it's important for the agent to select one of these. Importantly, when she does this, she is not identifying an object in the world, through perception: rather, she is actively imagining a certain object. Having imagined it, she can make it. (Note that both for normal transitive actions on existing objects, and actions of creation, the observer must activate a representation of the target object prior to performing the motor action.)

Say the agent has selected ‘a square’ as the object to be made. (assuming a drawing medium where shapes of different kinds can be produced). The agent must now engage the ‘object creation motor circuit’ which maps an imagined object onto a sequence of motor movements. In our model, executing a ‘make’ action is actually implemented as a mode-setting operation, rather than a first-order motor action: executing ‘make’ basically engages the object creation motor circuit, so that the sequence of first-order motor actions is driven by the selected (imagined) object to be made.

Having imagined an object and executed ‘make’, the agent will now execute a particular sequence of movements. As she does this, she also perceptually monitors the effects of these actions: it's not guaranteed that these will be as planned or expected. All of these processes are described in more detail in a separate paper (Takac et al., 2020).

When monitoring an action of creation in action perception mode, the observer watches some external agent execute a sequence of actions which create a new object of a certain type. This process also engages the object creation motor circuit and is used to generate expectations about the object being made. If these expectations are strong enough, and the observed agent stops or encounters difficulties in mid-action, and the observer may complete the action as expected.

Step 2b: Processing a Changer/Attendee Object by Itself

All of the above processing relates to Step 2a, where a causer object and a changer object have been independently identified. In Step 2b, there is a changer object, but no causer object—so the changer object is processed by itself.

In Step 2a, the causer tracker is stopped—but the changer tracker is maintained on the currently attended object. Three separate dynamic routines are executed.

One routine is the same change-detection routine that operates in Step 2a. Again, if a change is detected, the ‘go/become’ flag is set, and the final result state reached is recorded. In this scenario, unaccusative sentences like the glass broke, or Bill went red, or The door opened wide are produced.

The other two routines are the transitive action classifier and causative process classifier, configured to operate just on the changer object, to give passives. The causative process classifier only runs if change is also detected, giving sentences like The glass was broken. And the transitive action classifier only runs if neither change or causation are detected (e.g. in The cup was grabbed) or if both are detected (e.g. in The cup was punched flat).

Two Visual Trackers

In one embodiment, each participant that is attended is being tracked, by a dedicated visual tracker. Two distinct ‘visual object trackers’ are provided: one configured for the causer/attender object, and one configured for the changer/attendee object.

The two trackers deliver visual regions as input to different visual functions. The changer/attendee tracker provides input for the object classifier, and for a change detector and a change classifier. The causer/attender tracker provides input for an animate agent classifier (that places subtrackers on a head and motor effectors, if it can find them), a direction-of-attention classifier (that uses these subtrackers if they exist to implement gaze-following and movement extrapolation routines), and a causative-influence detector (that looks for regions in the tracked object's environment where it appears to be exerting causative effects).

At the start of event perception, when the first object is attended to, both trackers are assigned to this single object. The classifiers informed by the two trackers are then used competitively, to decide whether the object should be identified as a causer/attender (triggering causer/attender mode) or as a changer/attendee (triggering changer/attendee mode).

If the object is identified as a causer/attender, this must be because some evidence has been found for a second object, that is being attended to, and/or causally influenced. In causer/attender mode, the observer's next action is to attend to this second object. The changer/attendee tracker is now reassigned to this second object. This allows the second object to be classified (the object classifier takes its input from the visual region identified by the changer/attendee tracker). It also allows changes to be detected and classified in this second object.

The fact that the changer/attendee tracker is initially assigned to the first-attended object and in causer/attender mode is reassigned to a second object plays an important role in accounting for the causative alternation. In ‘the cup broke’, the system initially assigns the changer/attendee tracker to the cup, and then establish changer/attendee mode. In this mode, the system registers and classifies a change occurring in this first-attended object. In ‘Sally broke the cup’, the system initially assign both trackers to Sally, but then establish causer/attender mode, and hence reassign the changer/attendee tracker to the cup. In this mode, the system registers and classifies a change occurring in the second-attended object.

In summary, two independent visual trackers are provided, and configured to operate on different semantic targets. The causer tracker is set up to track the causer/attender; the changer tracker is set up to track the changer/attendee. A number of different mechanisms then operate on the visual regions returned by these trackers (which we'll refer to as the causer region and changer region respectively).

Mechanisms Operating on the Changer Region

Three mechanisms operate on the ‘changer region’ returned by the changer tracker.

The Object Classifier/Recogniser, and Associated Property Classifiers

One mechanism is a regular object classifier/recogniser. This delivers information about the type and token identity of the tracked object to the ‘current object’ medium. Alongside this mechanism, a set of property classifiers identify salient properties of the attended object individually. These are delivered to a separate part of the ‘current object’ medium, holding properties. Property classifiers are separated because some changes in the attended object are in particular properties, such as colour or shape.

The Change Detector

A second mechanism operating on the changer region is a change detector. This detector fires when some change in the tracked object is identified. The change detector has two separate components: a movement detector, that identifies change in physical location, and a property change detector, that identifies change in the properties identified by the property classifier. Changes in properties include changes in body configuration. Intransitive actions are frequently-occurring changes of this kind.

The Change Classifier

A third mechanism operating on the changer region is a change classifier. This classifier monitors the dynamics of the changer object in physical space and property space. If the changer object is animate, some dynamic patterns are identified by an intransitive action classifier, as changes that can be initiated voluntarily, like shrugs and smiles. That the changer object can be the observer herself. In this case, rather than a mechanism for classifying a perceived change, the system includes a mechanism for producing a change in the attended object, through the observer's motor system. A motor system that can execute intransitive actions is engaged.

Mechanisms Operating on the Causer Region

Two separate mechanisms operate on the ‘causer region’ returned by the causer tracker.

The Animate Agent Classifier

A first mechanism that operates on the causer region is an animate agent classifier. This mechanism attempts to locate a head and motor effectors (e.g. arms/hands) within the tracked region. If these are found, a head tracker and effector tracker are assigned to these sub-regions.

The observing agent can also attend to herself as the causer object. In this case, the roles of the head and effector tracker are played by the observer's own proprioceptive system, that tracks the position of her head, eyes and motor effectors.

The Directed Attention Classifier

If the animate agent classifier assigns a head tracker and/or effector trackers, a secondary classifier called the directed attention classifier operates on these. The directed attention classifier identifies salient objects near the tracked agent, based on the agent's gaze and/or extrapolated effector trajectories. If the observing agent is attending to herself as the causer, the directed attention classifier delivers a set of salient potential targets in the observer's own peripersonal space.

The Causative Influence Classifier

A final mechanism operating on the causer region is the causative influence classifier. This classifier assembles evidence that the tracked object is causally influencing its surroundings, by bringing about some change-of-state within these surroundings.

The agent learns that objects of certain kinds, in certain contexts, can causally achieve certain effects in certain locations. In such cases, the causative influence classifier draws the observer's attention to these regions. So functionally, it behaves like the directed attention classifier: it draws attention to salient regions near the tracked object.

If the observing agent is herself the causer, the issue is not whether the observer perceives a causative process at work, but which objects in the observer's surroundings she is able to exert a causative influence on—and which of these she might desire to exert a causative influence on. The mechanism functions to draw the agent's attention to a nearby object.

The causative influence classifier draws attention to places in the periphery of the causer object—but it also analyses the form, and perhaps the motion, of the causer object. Certain forms and motions are indicative of causative influence in certain directions, or at certain peripheral locations: for instance, the form and motion of a hammer moving along a certain path are indicative of causative influence on objects lying in that path. These forms and motions can certainly coincide with the forms and motions of transitive actions executed by animate agents—but they can also involve inanimate causative objects, as in the case of the hammer.

Mechanisms Operating Jointly on the Two Tracked Regions

A final set of mechanisms operate jointly on the causer and changer regions returned by the two trackers.

The Transitive Action Classifier

The first mechanism acting on both the causer and changer regions is the transitive action classifier. In an action perception mode, the transitive action classifier classifies patterns of agent-like movement in the object being tracked in the causer region—with particular attention to the object's motor effectors, if these have been identified. The animate agent classifier attempts to identify motor effectors, and assigns sub-trackers to these. In an action execution mode, the transitive action classifier generates motor movements, that are parameterised by the location of the agent's end effectors, and the selected target object.

In both modes, the agent's tracked end-effectors feature twice in the operation of the transitive action classifier. Firstly, the classifier monitors movements of the effectors towards the changer region, which is understood to be the place attended to by this agent. Transitive action categories are partly defined by particular trajectories of the agent's effector onto the target object: for instance, snatching, slapping and punching all involve characteristic trajectories. Secondly, the classifier monitors the shape and pose of the tracked motor effector. This effector may be any suitable effector, such as, but not limited to, a hand: The shape and pose of the agent's hand also help to identify transitive actions. Sometimes, the absolute shape of the hand is the important factor to consider: for instance, in a slap, the palm must be open; in a punch, it should be closed. But in other cases, the shape of the hand relative to the shape of the target object is the important factor (e.g. grasping actions).

The agent select some opposition axis in the object, and a compatible opposition axis in the hand, and then bring these two axes into alignment, by rotating the hand, and by opening it sufficiently on the selected axis to allow the object to come within it. Any suitable model of this may be implemented, such as that described in: M Rabbi, J Bonaiuto, S Jacobs, and S Frey. Tool use and the distalization of the end-effector. Psychological Research, 73:441-462, 2009.

In relation both to moving the effector to the target object and to aligning the opposition axes of the effector and target object, transitive action classification involves two tracking operations: 1. The effector being moved, as a sub-region of the whole agent (who in our model is also tracked independently); and 2. the target object. Therefore the transitive action classifier is a visual mechanism that operates ‘jointly on the two tracked regions’: the ‘causer’ region (tracking the agent and her effectors) and the ‘changer’ region (tracking the target object).

Although there are dedicated trackers associated with the agent and with the tracked object, the observer can sometimes represent a mixture of agent and object within a single tracked region. As the hand approaches the target object, it appears within the region associated with the tracked target object—(within the ‘changer’ region). At this point, the transitive action classifier can also directly compute a pattern characterising the hand's position and pose in relation to those of the target, and monitor the changes in this relative position and pose. If the observer of the action is the one performing it, these direct signals are useful for fine-tuning the hand movement. If the observed agent is someone else, these signals can help the observer make fine-grained decisions about the class of the action—or other parameters, like its manner (‘strong’, ‘gentle’, ‘rough’, and so on).

The Causative Process Classifier

The second mechanism operating on both tracked regions is a causative process classifier. This system attempts to couple the dynamics of the causer object (delivered by the causative agency classifier) with the dynamics of the changer object (delivered by the change classifier).

The simplest case to consider is one where the observer is monitoring an external causer object, and considering its relationship to an external changer object. In this case, the classifier simply makes a binary decision about whether the causer object's dynamics are causing those of the changer object. To do this, it attempts to predict the dynamics of the changer object from those of the causer object. If the predicted dynamics are as they would be given a causative process, the classifier sets the ‘cause’ flag in the WM event medium. If not, this flag is left unset.

The causative process classifier may be trained in any suitable manner on a large set of candidate causer and changer objects.

The causative process classifier also operates in a scenario where the observer has selected herself as the agent—that is, in the ‘action execution mode’. In this case, the role of the ‘cause’ flag is different. Executed actions are produced from an event representation that's reconstructed from the agent's LTM, that denotes an event that is desirable in the current context. Some such events involve causative processes that bring about a beneficial change-of-state in some target object. These events will have the ‘cause’ flag set. In such cases, the causative process classifier functions differently: it delivers a set of possible motor actions that produce the desired change-of-state. The agent selects one of these, and executes it. When monitoring the action, the agent (who is also the observer) must still gauge whether the intended causative process is actually forthcoming. If it is, the ‘cause’ flag can be set bottom-up, as it is in observation of an external causal process.

All actions that cause a change-of-state in some object must be transitive actions directed to that object.

If the observer selects herself as the agent, the experiments that train the causative process classifier can be particularly directed, because the putative ‘causer object’ is herself, and she has direct control over the dynamics of this object. In this scenario, the observer can actively test hypotheses about causal processes, by trying out multiple variants of a motor action to identify what parameters are essential to achieve a given effect. The same learning can also be done if the ‘causer object’ is something external to the observer, that she has no direct control over. This external object could be another agent—but it could also be an inanimate object, such as a fire, or a moving car, or a heavy weight.

In developmental terms, the causative influence classifier is acquired later than the causative process classifier. The causative influence classifier is trained on positive instances of causative processes identified by the causative process classifier. i.e. the causative influence classifier has to learn preattentional signatures of objects or places that are likely to be causally influenced by the currently selected causer object, of the kind that can draw the observer's attention to these objects or places. During mature event processing, the causative influence classifier operates before the causative event classifier. It basically establishes whether there are any grounds for deploying the causative process classifier—and if so, which object should be selected as the causally influenced changing object.

The Object Creation Motor Circuit

The final mechanism operating on both tracked regions is engaged during ‘actions of creation’, where the agent's motor movements create an object of a certain type, rather than just manipulating an existing object. Actions of creation are akin to transitive actions—except that the motor goal being pursued by the agent takes the form of an object representation (namely the object to be created). While normal transitive actions are executed by attending to the target object, an action of creation essentially involves imagining the object to be created, and then having this imagined object drive the motor system.

This driving happens through an object creation motor circuit. Like the causative process classifier, this circuit needs to be trained. While the causative process classifier learns a mapping from motor actions to changes-of-state, the object creation circuit learns a mapping from motor actions to the appearance of new object types. When the agent is learning to draw, for instance, she iteratively executes a sequence of random drawing movements on a blank background, at the location tracked by the changer classifier (and therefore passed as input to the visual object classifier). Every so often, these movements will create a form which the visual object classifier identifies as one of the object types it knows: for instance, a square, or a circle. In such a case, the object creation motor circuit learns a mapping from that particular movement sequence to the object type in question.

‘Unary’ Operation of Transitive Action Classifier and Causative Process Classifier

The transitive action and causative process classifiers just described are configured to operate on the causer and changer objects together: and they are trained in this configuration. after training, they can also operate on the changer object by itself. The event asserted by this sentence is one that can plausibly be identified directly through perception: that is to say, an observer can classify the transitive action ‘snatch’ without identifying the agent doing the snatching. Some aspects of a transitive action involve processes that are monitored purely by the tracker assigned to the target object (within the ‘changer’ region).

Causative sentences can be presented in the passive too: for instance, The glass was broken. The event described by this sentence is subtly different from the one described by the active change-of-state sentence The glass broke. The former sentence not only reports a change-of-state process happening in the glass: it also asserts that this process was caused by some other process. The causative process classifier can operate meaningfully on the changer object alone. That is, the classifier can detect something about a causative process when just monitoring the object undergoing a change-of-state. More speculatively, this property of the classifier is responsible for the existence of passive causatives.

Query Patterns

The system may support querying of WM Medium. A query of the form ‘What did X do?’ [where X is some agent] may retrieve both intransitive actions and transitive actions (including causative actions). ‘X’ is presented in the ‘first-object’ field of the WM event to specify this query.

Another is a query of the form ‘What happened to Y?’ [where Y is any object]. A single query retrieves events where Y underwent a change-of-state, and events where Y was the patient of a transitive action. ‘Y’ is presented in the ‘changer/attendee’ field of the WM event to specify this query.

### Advantages

Semantic models of events standardly include just one representation of the participant in each argument position. In the embodiments disclosed herein, each key participant is represented twice, rather than just once. The model features two representations of the key participants. This supports a clean mapping from semantics to syntax.

The model includes novel proposals about the component perceptual processes that support the deictic routine just outlined.

Categorization of the type of an event being monitored is an ‘incremental’ process, extended in time, that involves a sequence of discrete decisions (and attendant mode-setting operations). Event typology is considered from the perspective of real-time sensorimotor processing. This ties particular dimensions of variation between events to particular stages in the sensorimotor experience of events. The key idea is that there are particular times during event experience where a participant is registered as playing a particular semantic role, or where it is registered that a second participant is involved in the event. These decisions have localised effects in updating particular fields of the WM event representation, but also effects on all subsequent event processing, through the establishment of cognitive modes that endure for the remainder of event processing.

Each participant attended to during event processing is tracked thereafter, and some of these trackers are specialised for objects playing particular roles in an event (our ‘causer/attender’ and ‘changer/attendee’ trackers). Both these trackers are assigned to the same object to begin with, and one of them can be reassigned to a new object during the course of event processing.

Embodied Agent

In one embodiment, the Embodied Agent combines computer graphics/animation and neural network modelling. The agent may have a simulated body, implemented as a large set of computer graphics models, and a simulated brain, implemented as a large system of interconnected neural networks. A simulated visual system, takes input from a camera taking input from world (which may be pointed at a human users), and/or from the screen of a web browser page she and the user can jointly interact with. A simulated motor system controls the Embodied Agent's head and eyes, so the agent's gaze can be directed to different regions within the agent's visual feeds; and it controls the agent's hands and arms. In one embodiment, the agent is able to click and drag objects in the browser window (which is presented as a touchscreen in the agent's peri personal space). The Agent can also perceive events in which the user moves objects in the browser window, as well as events where these objects move under their own steam.

Embodiments described herein allow an embodied agent to describe experienced events in language—both events perceived by the agent, and events in which the agent participates. In one embodiment an agent produces a representation of an event incrementally, one component at a time. Representing events incrementally enables the rich, accurate event representations that are needed for a linguistic interface.

The model could feature in embodied agents to provide them with wide-ranging abilities to recognise events of different types (e.g. from video input), or to perform actions of different types (e.g. in their own simulated environment, and/or in the browser-window world they share with the user). For example an embodied agent may experience an event and store the event in WM. Then when the agent hears an utterance describing the event, and the agent learns an association between event structure and utterance structure.

### Advantages

The new model provides a method for an embodied agent to apprehend a wide variety of event types through interaction with the world. Prior methods for identifying events from video tend to focus on a single type of event (see e.g. Balaji and Karthikeyan, 2017), or a small set of event types (see e.g. Yu et al., 2015), or refrain from modelling event types at all, mapping sequences of video frames straight to sequences of words (see e.g. Xu et al., 2019).

Embodiments described herein solve several problems:
how to model the causative alternation: the fact that some verbs denoting a change-of-state allow the changing object to appear as the subject of an intransitive sentence (‘The glass broke’) but also as the object of a transitive sentence (‘Mary broke the glass’). (Linguists typically assume that at the level of semantics, the changing object has the same representation in these two cases: the problem is to explain why this representation is sometimes mapped to the subject and sometimes to the object.)
how to model syntactic Case. Case is manifested in English in the distinction between nominative noun phrases (e.g. ‘she’, ‘he’) and accusative noun phrases (e.g. ‘her’, ‘him’). In English, subjects always receive nominative Case, and objects always receive accusative Case. But in so-called ‘ergative’ languages, another pattern is found: the subject of an intransitive verb receives the same Case (called ergative) as the object of a transitive sentence, and the subject of a transitive sentence receives a different Case (called absolutive). Our new model provides a novel account of Case, which explains the origin of these distinct Case systems.
how to model passive sentences, such as ‘The cup was stolen’, or ‘The cup was broken’. The novelty here is in our account of the perceptual mechanisms through which events are apprehended.

The cognitive system described herein address how component perceptual mechanisms are combined in an overall perceptual system. Prior attempts at transitive action processing are extended to cover a much larger range of event types. A WM event representation holds copies of this medium, obtained at different points during event processing, when the ‘current object’ medium holds different object representations. The cognitive model incorporates change-of-state events by having the WM event representation record a ‘changer’ object and (optionally) a ‘causer’ object.

This allows embodied agents to report their sensorimotor experiences in language, and to be instructed by language to perform sensorimotor tasks.

Representing participant objects twice (once in the stored-sequence area and once in the causation/change area) helps encode the semantic aspects of event participants that determine (a) which participant becomes the syntactic subject of the sentence reporting the event and which becomes the syntactic object; and (b) support a model of passive sentences, pure change-of-state sentences, and the causative alternation.

The reassignment operation is crucial in giving an account of the ‘causative alternation’. Causative alternation is the phenomenon which allows an object changing state to sometimes appear as the grammatical subject of a sentence (e.g. ‘The cup broke’) and sometimes as the grammatical object (‘Sue broke the cup’). In this model, the grammatical subject is always the first-attended participant, and the grammatical object is always the second-attended participant. The perceptual mechanism that identifies (and monitors/classifies) a change-of-state must operate on the first-attended participant to recognise ‘The cup broke’, and on the second-attended participant to recognise ‘X broke the cup’. The visual tracker that delivers input to the change detector/classifier is initially assigned to the first participant, and then if need be, reassigned to the second participant.

### Interpretation

The methods and systems described may be utilised on any suitable electronic computing system. According to the embodiments described below, an electronic computing system utilises the methodology of the invention using various modules and engines. The electronic computing system may include at least one processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device. The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium. The electronic computing system is arranged to be in communication with data storage systems or devices (for example, external data storage systems or devices) in order to retrieve the relevant data. It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines. It will be understood that the arrangement and construction of the modules or engines may be adapted accordingly depending on system and user requirements so that various functions may be performed by different modules or engines to those described herein, and that certain modules or engines may be combined into single modules or engines. It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device. The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

### REFERENCE SIGNS LIST

1 Agent
2 Participant (object?)
3 Event Processor
4 Event
5 Tracker
6 Changer/Attendee
7 Causer/Attender
8 Action classifier

1. A computer implemented method for parsing a sensorimotor Event experienced by an Embodied Agent into symbolic fields of a WM event representation mapping to a sentence defining the Event including the steps of:
a. attending a participant object;
b. classifying the participant object; and
c. making a series of cascading determinations about the Event, wherein some determinations are conditional on the results of previous determinations,
wherein each determination sets a field in the WM event representation.

2. The method as claimed in claim 1 wherein at least some determinations trigger an alternative modes of cognitive processing in the Embodied Agent.

3. The method as claimed in claim 2 wherein the determinations for choosing between the alternative modes of cognitive processing in the Embodied Agent include the steps of:
a. defining an evidence collection process, that separately accumulates evidence for each mode over some period of time predating the time when the choice is to be made by an arbitrary amount; and
b. for each mode storing the accumulated evidence into a continuous variable denoting the amount of evidence accumulated for that mode,
c. determining the mode of cognitive processing is made by consulting the evidence accumulator variables for each mode.

4. The method as claimed in any preceding claim wherein determinations are selected from the group consisting of:
a. determining whether a second object exists;
b. determining whether there is evidence for an action of creation;
c. determining whether an object is undergoing a change-of-state; and
d. determining whether an object is exerting a causative influence, and/or executing a transitive action.

5. A data structure for parsing a sensorimotor Event experienced by an Embodied Agent into symbolic fields of a WM event representation including:
a WM Event Representation data structure including:
a. a causation/change area configured to store a causer/attender object and a changer/attendee object;
b. stored sequence area configured to store the first-attended object and second-attended object, holding re-representations of the objects in the causation/change area;
c. an action;
d. cause flag;
e. a field signalling that a change-of-state is under way; and
f. a result state.

6. The data structure of claim 5 further including a deictic representation data structure including: current object, configured to simultaneously map to both the causation change area and the stored sequence area.

7. A method for attending to objects by an embodied agent, including the steps of:
a. simultaneously assigning a causer/attender tracker and a changer/attendee tracker to a first object attended to by the embodied agent;
b. determining whether the first object is a causer/attender or a changer/attender; and
c. if the first object is a causer/attender, reassigning the changer/attendee tracker to the object being attended.

8. The method of claim 7 wherein attending the object is causally influencing the object.
